(19) United States
(12) Patent Application Publication
(10) Pub. No.: US 2016/0035168 A1
(43) Pub. Date: Feb. 4, 2016

(54) Multi-Circular-Track Ball-Drawing Device

(71) Applicant: Tzu-Hsiang Tseng, Taichung City (TW)

(72) Inventor: Tzu-Hsiang Tseng, Taichung City (TW)

(21) Appl. No.: 14/449,150

(22) Filed: Aug. 1, 2014

(51) Int. Cl. G07C 15/00

(52) U.S. Cl. CPC G07C 15/001

(57) ABSTRACT

A multi-circular-track ball-drawing device includes at least two vertically adjacent circular ball-delivering units that are such arranged that directions thereof include an angle of 90°. Each of the circular ball-delivering units has transparent upper and lower semicircular housings. The upper and lower semicircular housings are such joined by the curved joining pieces that upper and lower openings are foamed. The upper opening of the lower circular ball-delivering unit connects the lower opening of the upper circular ball-delivering unit through a ball-feeding platform. Thereby, the whole process where lottery balls are transported through the circular ball-delivering units is visible from outside. The lottery balls transported through the circular ball-delivering units are selectively accumulated and change an order thereof on the ball-feeding platform, making the ball drawing more unpredictable and more exciting.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to lottery-drawing machines, and more particularly to a multi-circular-track ball-drawing device, which provides lottery-drawing spectators with visibility throughout a process where lottery balls in the device are mixed and drawn by random.

2. Description of Related Arts

The conventional lottery-ball drawing machines typically use a blower to blow and thereby mix lottery balls in a mixing barrel with strong wind power. The lottery balls are intensely mixed for adequate randomness and fairness as expected from a lottery-drawing process. However, the foregoing configuration has some shortcomings:

1. The number of lottery balls mixed in the mixing barrel is usually large. With the high intensity of mixing operation, the lottery-drawing spectators, who may usually be the lottery bettors, are unlikely to clearly witness whether the lottery balls associated with his/her interests have the odds to be drawn. What he/she can do throughout the drawing process is waiting until the lottery balls are drawn and displayed, making the spectators and/or related bettors feel less relevant. Therefore, there is a need for making the drawing process more relevant and more interesting to the spectators and/or related bettors; and

2. When the blower mixes the lottery balls with strong wind, the balls tend to impact the mixing barrel or other balls heavily. Such impact is undesired as it not only causes huge noise, but also damages the lottery balls.

Hence, the inventor of the present invention has paid efforts to improve the existing lottery-drawing machines with the attempt to allow the spectators and/or related bettors to enjoy more excitement and more enjoyment during a lottery ball-drawing process.

### SUMMARY OF THE PRESENT INVENTION

For addressing the shortcomings of the prior art, the present invention provides a multi-circular-track ball-drawing device.

The objective of the present invention is to provide the multi-circular-track ball-drawing device that comprises a plurality of circular ball-delivering units that are arranged vertically aligned while facing different directions, so that circular ball-circulating tracks of the circular ball-delivering units are connected in series. During the process where lottery balls are transported from the bottommost circular ball-delivering unit to the upmost circular ball-delivering unit, the lottery balls are well mixed and selectively accumulated on a platform, making the ball drawing more unpredictable and more exciting.

Another objective of the present invention is to provide the multi-circular-track ball-drawing device, wherein the circular ball-delivering unit has a helm-like wheel. The helm-like wheel is peripherally provided with a plurality of blades. The helm-like wheel is coupled to the transmission assembly so that it can roll. The blades serve to take, transport and discharge lottery balls in, along and out of the circular ball-delivering mechanism. The circular ball-delivering mechanism includes transparent upper and lower semicircular housings that house the helm-like wheel and make the path of the lottery balls visible from outside. Thereby, a related bettor is allowed to watch the ball-drawing process with more excitement and more enjoyment.

Another objective of the present invention is to provide the multi-circular-track ball-drawing device that implements the motor to drive the circular ball-delivering units, so the lottery balls are less impacted. This is helpful to not only reduce noise, but also prevent the lottery balls from being damaged.

### BRIEF DESCRIPTION OF THE DRAWINGS

FIG. 1 is an exploded view of a multi-circular-track ball-drawing device according to the present invention.

FIG. 2 is a perspective view of the multi-circular-track ball-drawing device.

FIG. 3 is a cross-sectional view of the multi-circular-track ball-drawing device according to the present invention.

FIG. 4 is an exploded view of a circular ball-delivering unit of the multi-circular-track ball-drawing device according to the present invention.

FIG. 5 is a cross-sectional view of the circular ball-delivering unit.

FIG. 6 shows the operation of the circular ball-delivering unit.

FIG. 7 shows the operation of the multi-circular-track ball-drawing device.

### DETAILED DESCRIPTION OF THE PREFERRED EMBODIMENT

The invention as well as a preferred mode of use, further objectives and advantages thereof will be best understood by reference to the following detailed description of illustrative embodiments when read in conjunction with the accompanying drawings.

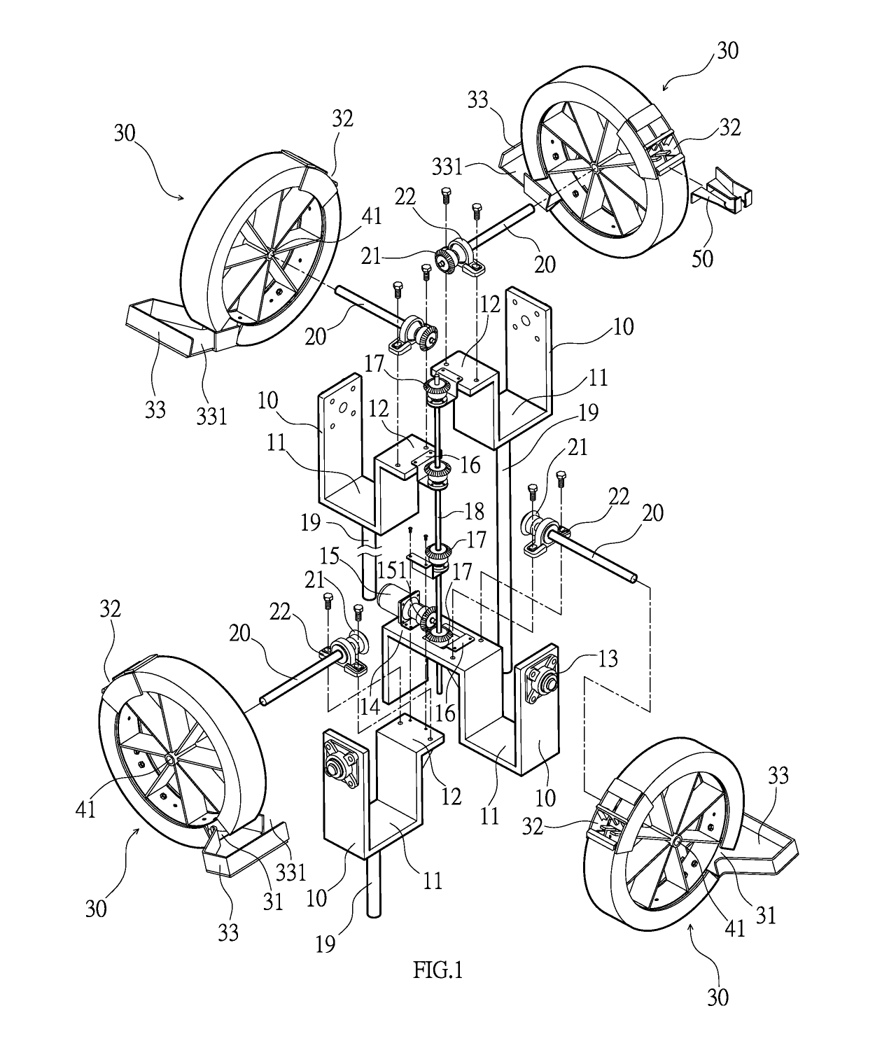

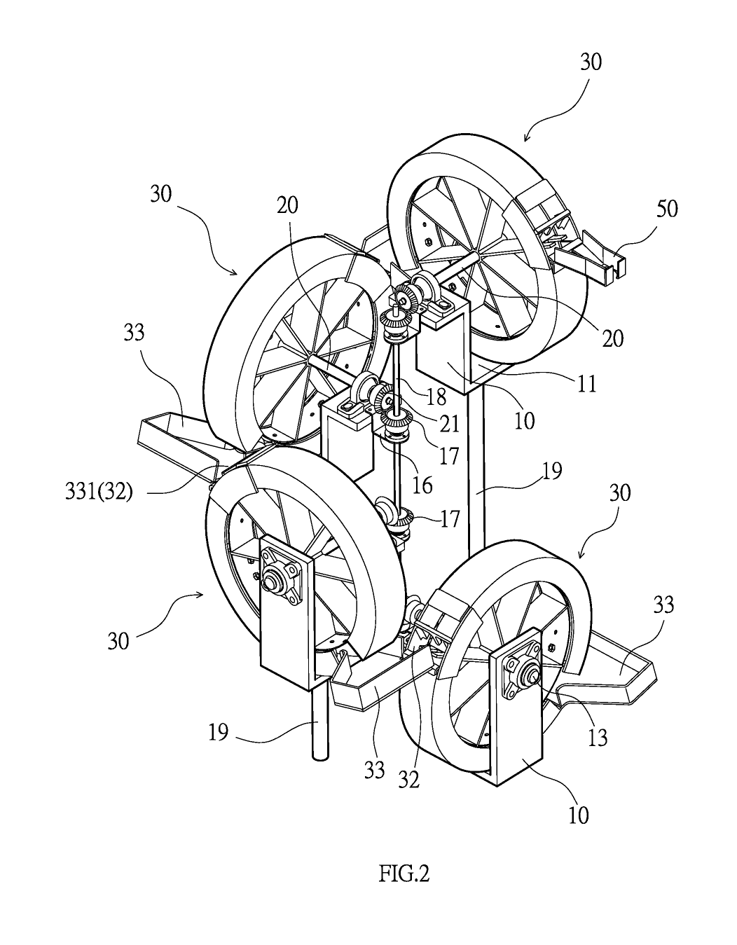

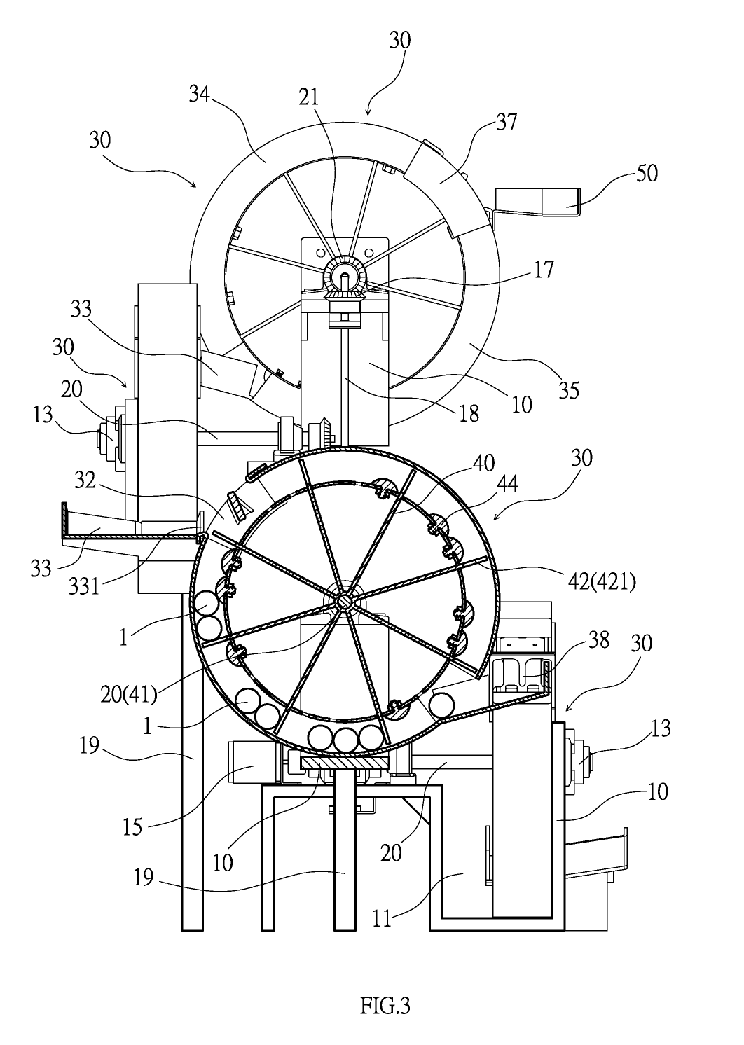

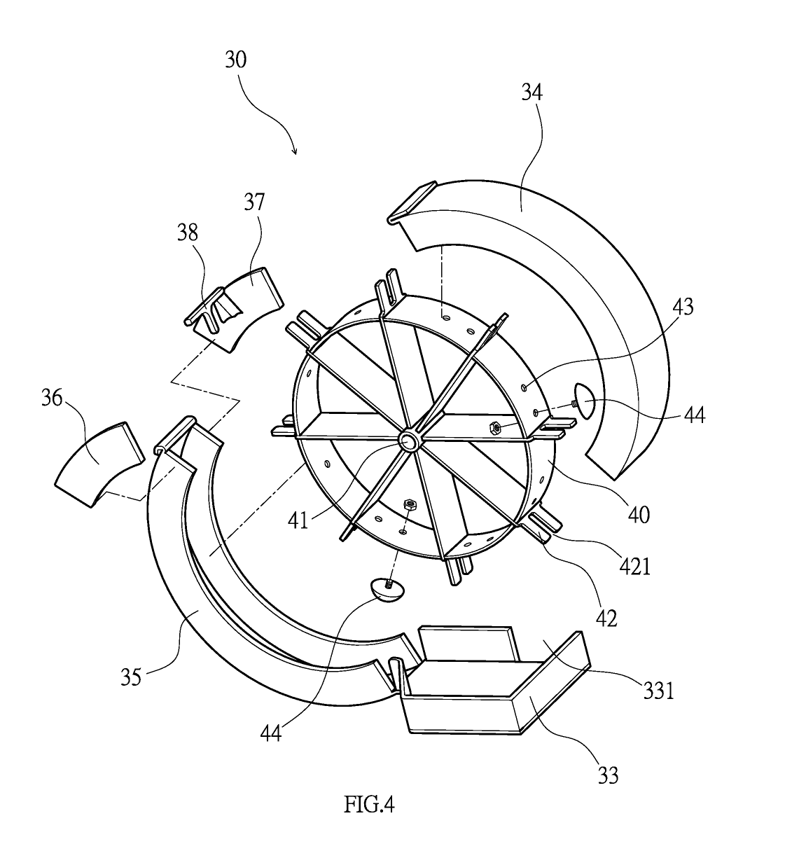

Please refer to FIG. 1 through FIG. 5. According to the present invention, a multi-circular-track ball-drawing device comprises at least two supports 10 between which a vertical distance is set. Each of the support 10 has a U-shaped receiving portion 11 that is constructed from a multi-turn board. The support 10 has its front surface equipped with a shaft seat 13, and has its rear part formed with a level shelf 12. A level fixing plate 16 is attached to a rear end of the shelf 10 for carrying an intermediary bevel gear 17. The receiving portion 11 receives a circular ball-delivering unit 30 that is coupled to a driving shaft 20. The circular ball-delivering unit 30 has its lower part at one side provided with a ball-feeding platform 33 that has a lower opening 31, and has its upper part at an opposite side provided with an upper opening 32. The driving shaft 20 has its front end rotatably received in the shaft seat 13, and is positioned on the shelf 12 by a holder 22 it passes through. The driving shaft 20 has its rear end equipped with a driven bevel gear 21 that engages with the intermediary bevel gear 17. The at least two vertically adjacent intermediary bevel gears 17 are connected by an upright trace 18, so that they move together and synchronously. The vertically adjacent upper and lower supports 10 are such arranged that their directions include an angle of 90°. Consequently, the upper opening 32 of the lower circular ball-delivering unit 30 is open to the ball-feeding platform 33 of the upper circular ball-delivering unit 30. A ball-present platform 50 is provided at the upper opening 32 of the upmost circular ball-delivering unit 30. In addition, the support 10 of the bottommost has its shelf 12 rearward extended with an extension section 14, on which a motor 15 coming with a driving bevel gear 151 is installed. The driving bevel gear 151 engages with the intermediary bevel gear 17 so as to drive the trace 18, and in turn drive all the driving shafts 20 to rotate, making the circular ball-delivering units 30 operate to transmit the lottery balls 1 therein. Of course, the extension section 14 and the motor 15 may be alternatively provided at another said support 10 to drive the trace 18 and the driving shafts 20 similarly.

The circular ball-delivering unit 30 is housed by an upper semicircular housing 34 and a lower semicircular housing 35 that are such joined at an upper joint by two curved joining pieces 36, 37 that the upper opening 32 is formed. A T-shaped ball-retaining bar 37 spans across the two curved joining pieces 36, 37 in a predetermined angle. At a lower joint between the upper and lower semicircular housings 34, 35, a ball-feeding platform 33 is attached to the lower semicircular housing 35 so as to form a lower opening 31. The combination of the upper and lower semicircular housings 34, 35 is then mounted received in the U-shaped receiving portion 11. The upper and lower semicircular housings 34, 35 jointly shell a helm-like wheel 40, without contacting it. The helm-like wheel 40 is provided centrally with an axial hole 41, and is provided peripherally with a plurality of blades 42 each having a passing slot 421. The passing slot 421 is such configured that the ball-retaining bar 38 can pass therethrough without hitting the blade 42. Between the blades 42 of the helm-like wheel 40 and the upper and lower semicircular housings 34, 35, a ball-circulating track 39 is defined. The helm-like wheel 40 is further provided peripherally with a plurality of through holes 43. Each of the through holes 43 allows a filling member 44 to pass therethrough and combine with a nut. When the helm-like wheel 40 rolls, these filling members 44 are free from being retained by the ball-retaining bar 38. This allows adjustment of the number of the lottery balls 1 in the ball-circulating track 39.

With the aforementioned configuration, plural lottery balls 1 may be taken into the ball-circulating track 39 through the bottommost lower opening 31 and circulate in the circular ball-circulating track 39 One said lottery ball 1 later gets gripped and launched out the upmost upper opening 32 by the blade 42 and the ball-retaining bar 38. Between the multiple circular ball-delivering units 30, the lottery balls 1 maybe accumulated, so as to provide more variety of taking, rearranging and discharging the lottery balls 1.

The components used in the present invention are to be described in detail below. Please refer to FIG. 1 through FIG. 5. In the circular ball-delivering units 30, the upper semicircular housings 34 and the lower semicircular housings 35 having the ball-feeding platforms 33 are all made of a transparent plastic material, so can be seen through from outside. The upper and lower semicircular housings 34, 35 are joined by the curved joining pieces 36, 37 into a circular case, and the upper and lower openings 31, 32 are formed at the joints therebetween. The combination of the upper and lower semicircular housings 34, 36 is then fixed to the support 10 and received in the receiving portion 11 in a non-rotatable manner. The blades 42 are sandwiched by the upper and lower semicircular housings 34, 35 so as to form several closed rooms where the lottery balls 1 are carried by the blade 42 without coming off. There is an altitude difference between lower opening 31 and the upper opening 32 of the same circular ball-delivering unit 30. To connect the upper opening 32 of one said circular ball-delivering unit 30 to the ball-feeding platform 33 of a next said circular ball-delivering unit 30, the support 10 is adjusted in height by means of a prop 19 provided therebelow, so that the upper opening 32 and the ball-feeding platform 33 are leveled and connected. The supports 10 and the circular ball-delivering units 30 are assembled with the axis of the intermediary bevel gear 17 as their common axis. The supports 10 are such arranged that the directions of each two vertically adjacent supports 10 include an angle of 90°. In this manner, the upper opening 32 of the lower circular ball-delivering unit 30 is aligned to a side edge of the ball-feeding platform 33 of the upper circular ball-delivering unit 30. Thus, the side edge of the ball-feeding platform 33 connecting the upper opening 32 is provided with an opening 331, which allows the lottery balls 1 to enter the lower opening 31 therethrough.

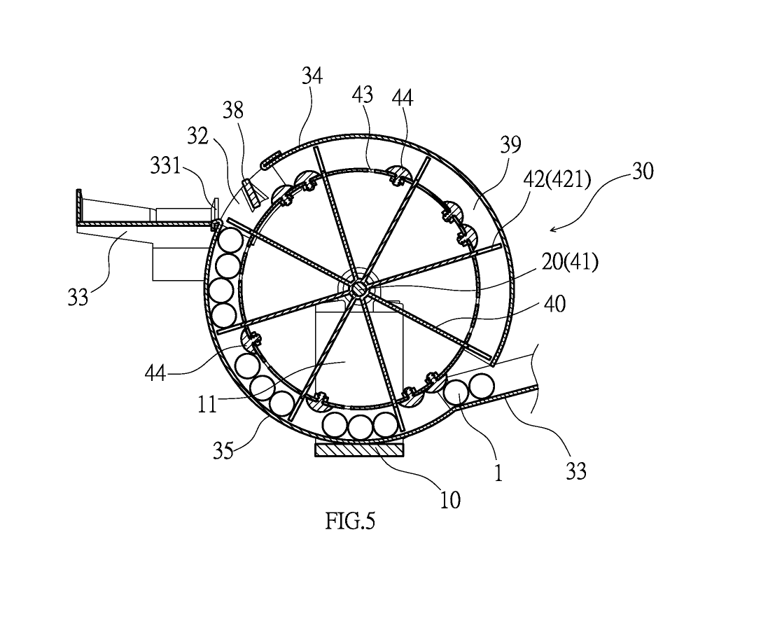

Please refer to FIG. 5, when plural lottery balls 1 have been built up at the ball-feeding platform 33 of the circular ball-delivering unit 30, the tilted ball-feeding platform 33 makes the lottery balls 1 to roll toward the lower opening 31. Since the ball-feeding platform 33 is tapered toward the lower opening 31 allows only one lottery ball 1 to pass a time, the lottery balls 1 jostle forward while having their locations and order randomly changed, and then enter the ball-circulating track 39 as the helm-like wheel 40 rolls. The passing slot 421 of the blade 42 has a width smaller than a diameter of the lottery ball 1, so the lottery balls 1 are pushed forward along the ball-circulating track 39 by the blades 42. The blades 42 divide the ball-circulating track 39 into several rooms. The provision of theses rooms, together with the arrangement of the filling members 44, makes it possible to control and change the number of the lottery balls 1 received in the ball-circulating track 39, thereby changing the number and velocity of the lottery balls 1 drawn. Thereby, during the foregoing process, a bettor can watch the lottery balls 1 to see whether the one(s) of his/her interests has (have) the odds to be drawn first.

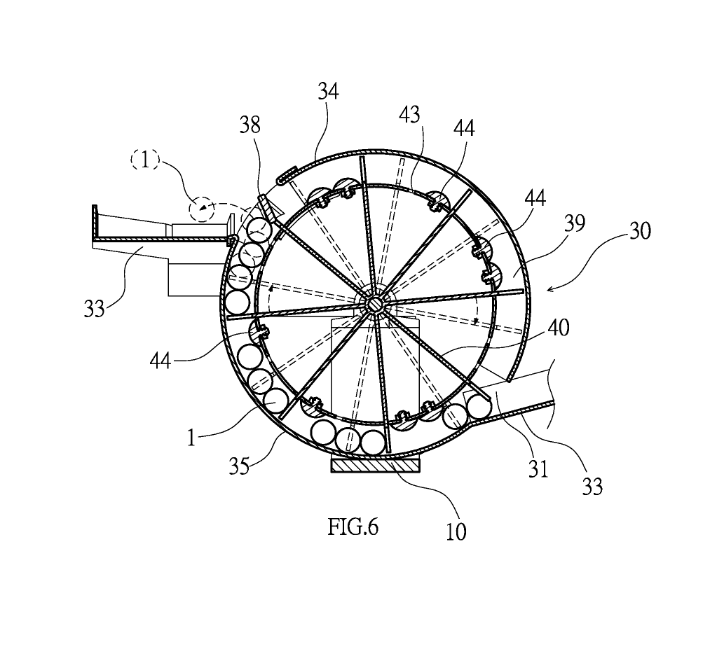

Referring to FIG. 6, when the lottery balls 1 are sent to the upper opening 32, the T-shaped ball-retaining bar 38 spans across the curved joining pieces 36, 37 and has its straight rod extending into the in a predetermined angle ball-circulating track 39, so that the lottery ball 1 can be retained by the T-shaped ball-retaining bar 38. Each of the ball-retaining bar 38 and the blades 42 is made of metal or rigid plastic and formed with smooth surfaces. Since the blade 42 of the helm-like wheel 40 and the ball-retaining bar 38 include an outward opening angle, the moving blade 42 and the ball-retaining bar 38 can jointly grasp the smooth lottery ball 1 and force the lottery ball 1 to jump out to the ball-present platform 33 of the next circular ball-delivering unit 30 through the upper opening 32.

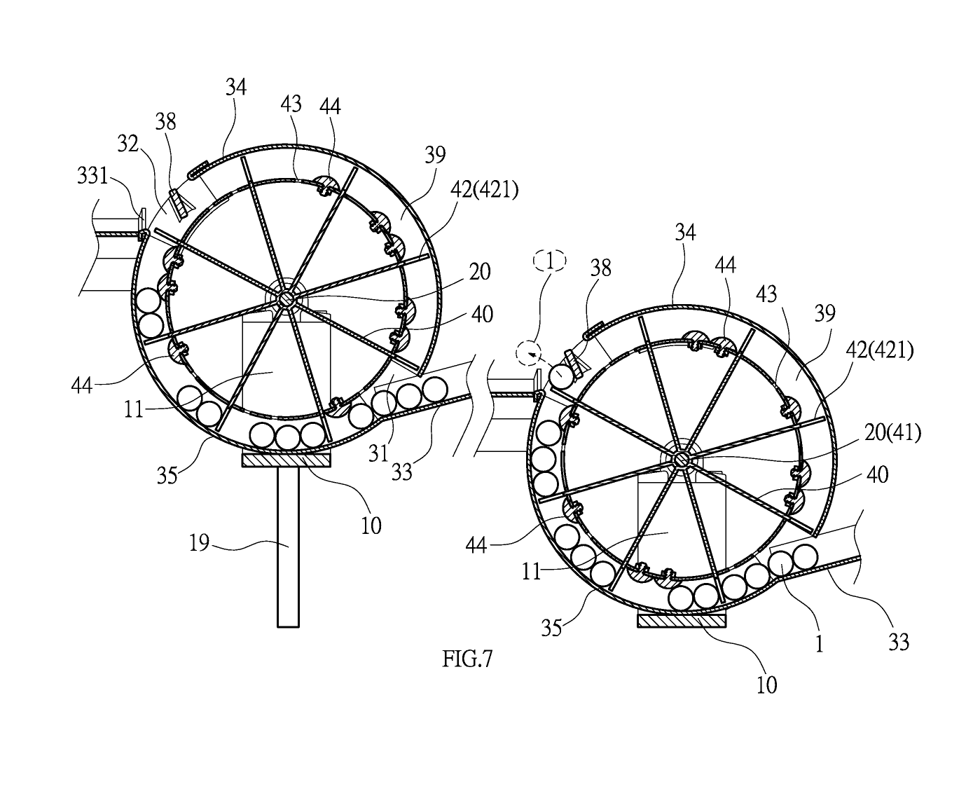

Referring to FIG. 7, when the lottery balls 1 are transported through the multiple ball-circulating tracks 39, since the helm-like wheels 40 of the circular ball-delivering unit 30 are driven by the intermediary bevel gears 17 and the driven bevel gears 21 of the same diameter, they share the same rotational speed. For modifying the ball-delivering rate and number, the filling members 44 are selectively arranged between the blades 42 of the helm-like wheel 40, so that the number of the lottery balls 1 transported by the helm-like wheel 40 in its single turn is set. Also, the numbers of the lottery balls 1 received in the individual rooms between the blades 42 can be adjusted. With the premise that the sum lottery balls 1 remains the same across the individual circular ball-delivering units 30, the lottery balls 1 can be at times accumulated on and at times cleared from the ball-feeding platform 33 between two said circular ball-delivering units 30. In the case of accumulating, the lottery balls 1 can jostle with increased intensity, making the order of the lottery balls 1 more unpredictable. In other words, one lottery ball 1 had led the way to the ball-present platform 50 may suddenly fall behind. This additional mixing operation adds more excitement and emotional changes to the bettor(s) watching the drawing process.

One example is herein described for non-limiting explanation. Therein, the previous circular ball-delivering unit 30 has the ball numbers in the rooms between its blades 42 set as: 3, 4, 2, 3, 2, 4, 2, 3, namely 23 in total, while the next circular ball-delivering unit 30 has the ball numbers in the rooms between its blades 42 set as: 2, 2, 3, 4, 3, 2, 4, 3, also 23 in total. In operation, the ball-feeding platform 33 between the two may take in balls 1 from the previous circular ball-delivering unit 30 and then sends some of the balls 1 to the next circular ball-delivering unit 30. By subtracting the number of the outputting balls from the number of the incoming balls, the number of the balls accumulated in the present ball-feeding platform 33 is obtained. Therefore, during a turn of the helm-like wheel 40, numbers of the balls accumulated on the ball-feeding platform 33 are: 1, 3, 2, 1, 0, 2, 0, 0. Further assuming that the ball numbers in the rooms between the blades 42 of the previous circular ball-delivering unit 30 remain unchanged, and that of the next circular ball-delivering unit 30 are set as: 3, 2, 2, 3, 4, 3, 2, namely 23 in total, then in operation, the numbers of the balls accumulated on the ball-feeding platform 33 are: 0, 1, 1, 2, 1, 1, 0, 1. With this configuration, the numbers of the balls 1 across the circular ball-delivering units 30 can be such designed that the number of the accumulated balls changes over time. This, plus the ball taking, mixing and delivering operation throughout the multiple circular ball-delivering units, allows the balls 1 to be completely scattered and rearranged, and in turn gives the watching bettors more visual and emotional excitement.

It is to be noted that for the helm-like wheel 40 to roll, the motor 15 drives the driving bevel gear 151 to activate plural intermediary bevel gears 17 that further drive driven bevel gears 21 through the and the trace 18, thereby using the driving shaft 20 to rotate the helm-like wheel 40. Since the lottery balls 1 are transported throughout the process without impacting each other, noise appearing can be reduced.

The present invention has been described with reference to the preferred embodiments and it is understood that the embodiments are not intended to limit the scope of the present invention.

Moreover, as the contents disclosed herein should be readily understood and can be implemented by a person skilled in the art, all equivalent changes or modifications which do not depart from the concept of the present invention should be encompassed by the appended claims.

What is claimed is:

1. A multi-circular-track ball-drawing device, comprising at least two support between which a vertical distance is set, the support being constructed from a multi-turn board to provide a receiving portion, having a front surface thereof equipped with a shaft seat, and having a rear part thereof formed with a level shelf on which an intermediary bevel gear is installed, each said receiving portion receiving a circular ball-delivering unit coupled to a driving shaft, the circular ball-delivering unit having an lower opening with a ball-feeding platform at a lower part of one side thereof, and having an upper opening at an upper part of an opposite side thereof, the driving shaft having a front end rotatably received in the shaft seat and a rear end provided with a driven bevel gear that engages with the intermediary bevel gear, the at least two vertically adjacent intermediary bevel gears being connected by an upright trace so as to move synchronously, and the vertically adjacent supports are such arranged that directions thereof include an angle of 90°, thereby allowing the upper opening of the lower circular ball-delivering unit connects the ball-feeding platform of the upper circular ball-delivering unit.

2. The multi-circular-track ball-drawing device of claim 1, wherein one of the supports further has an extension section extended from a rear end of the shelf, on which extension section a motor of a driving bevel gear is installed, and the driving bevel gear engages the intermediary bevel gears to drive the trace to rotate.

3. The multi-circular-track ball-drawing device of claim 1, wherein the upper support has a prop at a bottom thereof.

4. The multi-circular-track ball-drawing device of claim 1, wherein a level fixing plate is attached to a rear end of the shelf, on which fixing plate the intermediary bevel gear is installed.

5. The multi-circular-track ball-drawing device of claim 1, wherein the supports, and in turn the circular ball-delivering units, are arranged against the intermediary bevel gears so that the directions thereof include an angle of 90°.

6. The multi-circular-track ball-drawing device of claim 1, wherein the circular ball-delivering unit is housed by an upper semicircular housing and a lower semicircular housing, which are such joined at an upper joint by two curved joining pieces that an upper opening is formed, wherein a T-shaped ball-retaining bar spanning across the two curved joining pieces in a predetermined angle; at a lower joint between the upper and lower semicircular housings, a ball-feeding platform is attached to the lower semicircular housing so as to form a lower opening; the upper and lower semicircular housings such assembled being assembled to a transmission assembly; the upper and lower semicircular housings jointly shelling but not contacting a helm-like wheel; the helm-like wheel being provided centrally with an axial hole and being provided peripherally with a plurality of blades each having a passing slot, wherein the passing slot allows the ball-retaining bar to pass freely therethrough; and between the blades of the helm-like wheel and the upper and lower semicircular housings a ball-circulating track is defined.

7. The multi-circular-track ball-drawing device of claim 6, wherein the helm-like wheel is peripherally provided with a plurality of through holes, and a plurality of filling members are attached to the helm-like wheel by each passing through a said through hole and combining with a nut.

8. The multi-circular-track ball-drawing device of claim 6, wherein the upper semicircular housing and the lower semicircular housing are both made of transparent plastic.

9. The multi-circular-track ball-drawing device of claim 6, wherein the passing slot of the blade has a width smaller than a diameter of the lottery ball.
